(19) United States
(12) Patent Application Publication
(10) Pub. No.: US 2011/0102887 A1
(43) Pub. Date: May 5, 2011

(54) FAST, MODULAR PORT SWITCHER FOR AN OPTICAL MICROSCOPE USING A GALVANOMETER

(75) Inventor: Glen Ivan Redford, Arvada, CO (US)

(73) Assignee: INTELLIGENT IMAGING INNOVATIONS, INC., Denver, CO (US)

(21) Appl. No.: 12/917,102

(22) Filed: Nov. 1, 2010

Related U.S. Application Data
(60) Provisional application No. 61/257,640, filed on Nov. 3, 2009.

(51) Int. Cl. G02B 21/18

(52) U.S. Cl. 359/372

(57) ABSTRACT

A fast modular port switching device is used with an optical microscope to facilitate using multiple devices with the microscope. The port switching is done with a galvanometer for switching very fast. The device is modular so it can be combined with any number of similar devices for building a complex, multi-modal imaging system. Also described is the combination of a port switcher with automated spherical aberration correction. Also described is a similar device where the outputs are recombined, thus making the device a fast filter switcher.

### RELATED APPLICATION DATA

This application claims the benefit of and priority under 35 U.S.C. §119(e) to U.S. Patent Application Ser. No. 61/257,640 filed Nov. 3, 2009, entitled “Fast, Modular Port Switcher for an Optical Microscope using a Galvanometer,” which is incorporated herein by reference in its entirety.

### FIELD

An exemplary embodiment of this invention generally relates to optical path switching in optical microscopes. More specifically, an exemplary embodiment relates to a modular port switcher device. Even more specifically, an exemplary embodiment of the invention relates to a modular port switcher device which is external to the main microscope. Even more specifically, an exemplary embodiment of the invention relates to a galvanometer-based port switcher device. Even more specifically, an exemplary embodiment of the invention relates to a combination of a port switcher device and a spherical aberration correction device. Additionally, an exemplary embodiment of this invention relates to a modular filter switcher device. Even more specifically, and exemplary embodiment of this invention relates to a galvanometer-based filter switcher device.

### BACKGROUND

Modern digital microscopy is more and more multi-modal. More frequently there are found multiple imaging devices and specialized illumination devices. For example, it is not uncommon for a light microscope to be capable of wide-field imaging as well as optical sectioning. Lasers, detectors, scanners, and other devices are now added in ever increasing numbers to a single system. The benefit is that a single specimen can be analyzed in many different ways to increase the amount of information collected. Modern motorized microscopes often are equipped with multiple documentation ports to accommodate multiple devices. These documentation ports are automated and can be switched between with the controlling computer. Currently these devices take several seconds to perform a switch. In many cases this is too slow to see transitory signals. Switching times becomes important for multi-modal systems.

Modern microscopy also takes advantage of high NA objectives and high resolution imaging. Spherical aberration limits the use of such objectives to only ideal imaging situations. A separate patent application, “Spherical Aberration Correction for an Optical Microscope using a Moving Infinity-Conjugate Relay,” describes means for correcting spherical aberration.

In fluorescence microscopes, it is also more common to perform multi-channel imaging, meaning that fluorophores of different colors are sequentially imaged. In multi-channel imaging, a common method of separating the colors is to move different color filters into the optical pathway. During rapid acquisition, the time for the filter to change is often the rate limiting step.

### SUMMARY OF THE INVENTION

Outside of the main body of the microscope there is a location in the optical train called the image plane. This is the location where the specimen of interest may be imaged with an optical device such as a camera. Should one wish to send the image to more than one optical device, one could insert a mirror before the image plane and send the light to the second device. This does not allow much room for multiple devices as the image plane is generally near the body of the microscope. This also has the disadvantage that the mirror is in a converging beam space and so any imperfections on the mirror will show up in the image.

A better idea is to relay the image to a point further from the microscope and then redirect it to the different devices. This can be done optically in many ways, but the ideal way to do this is to use an infinity-conjugate relay. This has a benefit of an infinity space within the relay which is an ideal space for a mirror. In an infinity space, imperfections in the mirror have a much lesser effect on the image. An infinity space is also the ideal location to place an optical filter. Also, an infinity-conjugate relay is easy to make free of image distortions.

A galvanometer can be used to create a very fast turning mirror. This is inserted into the infinity space of the relay, which creates a number of optical paths. The image is then directed to a number of different devices.

Accordingly, one exemplary embodiment of the invention is directed toward a galvanometer-based port switcher. The galvanometer is used to redirect the image to a number of different optical paths. This galvanometer will typically be controlled by an electronic system such as a computer. The electronic control will allow the galvanometer to by synchronized to other devices.

One exemplary relay system involves three positive lenses. The first lens is placed the distance of its focal length from the image plane. The galvanometer is placed between the lenses, creating a path from the first lens to the second or from the first to the third. Ideally the distance between the two lenses is equal to the sum of their focal lengths. If positioned correctly and if the two lenses are equal, a “zero” point can be established where the original focal plane is imaged with no additional magnification or distortion. This condition can be met for both optical paths.

The exemplary apparatus can comprise:

an optical relay with at least two optical paths, which are selected by means of a reflecting device such as a mirror, and

a means for moving the mirror.

This exemplary apparatus would provide means for selecting between two (or more) devices which are optically coupled to the microscope.

If the device is made modular, meaning that it is mechanically and optically a separate unit, it can be combined with other such devices for more complicated multi-modal operation. Ideally, each input/output port is optically identical. To do this, a mechanical and optical standard is adhered to for each port. An exemplary embodiment of such a standard is one where the image plane and the acceptance angle are fixed relative to the mechanical coupling of a port. Ideally, (even though not required) this standard is symmetric, so a given port can act as an input or output.

Because an infinity conjugate relay is the primary part of one method of correcting for spherical aberration in microscopy, one can take advantage of the relay present in the port switching device to additionally correct for spherical aberration. All that would be additionally required would be means for moving the input lens along the optical axis. This would allow finding and relaying the desired aberration-free image from the focal volume.

An additional exemplary relay system consists of two positive lenses which create an infinity space between them. In this space, a galvanometer can be used to direct the light through one of several optical filters. The light paths are then recombined using mirrors or polychromatic mirrors and sent out of the relay.

The exemplary device can comprise:

an optical relay with at least two paths which are selected by means of a reflecting device such as a mirror,

means for moving the mirror, such as a controller and associated motorized element(s) and/or drive units, and

appropriate optics for recombining the optical paths into a single output.

This apparatus would provide means for selecting one of several optical filters placed in the several optical paths.

Aspects of the invention are thus directed toward port switching in optical microscopes.

Still further aspects of the invention are directed toward a modular port switcher device.

Even further aspects of the invention are directed toward a modular port switcher device which is external to the main microscope.

Still further aspects of the invention are directed toward galvanometer-based port switcher device.

Even further aspects of the invention are directed toward a fast modular port switcher that can be combined with other such devices to build a complicated multi-modal device.

Even further aspects of the invention are directed towards a combination port switching device and spherical aberration correction device.

Even further aspects of the invention are directed to a filter switching device.

Still further aspects of the invention are directed to a galvanometer based filter switching device.

Even further aspects of the invention are directed toward automated control and software for the device.

Still further aspects of the invention relate to an apparatus for port switching including:

a relay system with at least two optical paths selected by a reflective device;

means for moving the reflective device; and

means for controlling the motion of the reflective device to select the desired optical path.

The aspect above, where the reflective device is motorized.

The aspect above, where the reflective device is motorized by using a galvanometer.

The aspect above, where the motorization control device is synchronized with the detector.

The aspect above, where the means for moving the reflective device can do so in under the transfer time of the imaging camera.

The aspect above, where the input lens of the relay can be moved along the optical axis.

The aspect above, where the optical paths are then recombined to a single output.

The aspect above, where optical filters are placed in the several paths.

The aspect above, where the apparatus is combined with an optical microscope.

The aspect above, where the apparatus is combined with an electronic imaging device such as a camera.

The aspect above, where the apparatus is combined with a scanning microscope.

The aspect above, where the scanning microscope is a confocal microscope.

The aspect above, where the scanning microscope is a two-photon microscope.

The aspect above, where the apparatus has a “zero” mode where the effective images are unaltered from the image were the apparatus not present.

The aspect above, where the apparatus is automated and controlled with a computer program.

Additional aspects of the invention also relate to a modular, high-speed galvo port switcher that enable custom advanced microscope applications. The port switcher allows rapid, (e.g., 1 ms) selection of two optical output (or two input) paths for one input (output). This enables, for example, direct combination of multiple devices and methods.

These and other features and advantages of this invention are described and, or are apparent from, the following detailed description of the exemplary embodiment.

### BRIEF DESCRIPTION OF THE DRAWINGS

The exemplary embodiments of the invention will be described in detail, with reference to the following figures wherein:

FIG. 1 illustrates an exemplary optical diagram of a port switcher.

FIG. 2 illustrates an exemplary port switcher device.

FIG. 3 illustrates an exemplary optical diagram of a port switcher including spherical aberration correction.

FIG. 4 illustrates and exemplary optical diagram of a filter switcher.

### DETAILED DESCRIPTION

The exemplary embodiments will be described in relation to microscopes, imaging systems, and associated components. However, it should be appreciated that, in general, known components will not be described in detail. For purposes of explanation, numerous details are set forth in order to provide a thorough understanding of the present invention. It should be appreciated however that the present invention may be practiced in a variety of ways beyond the specific details set forth herein.

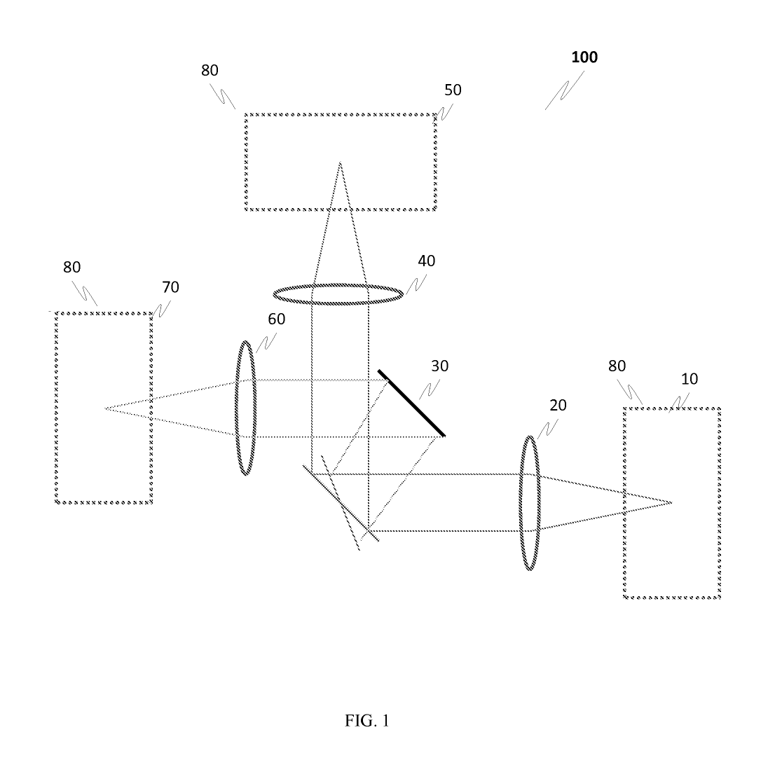

FIG. 1 illustrates an exemplary optical diagram of a port switcher 100. The input image 10 is imaged with lens 20 which forms an infinity space between the lenses. The light path hits a moving mirror 30. The light is directed to lens 40 which recreates the image at 50. Alternatively, the mirror redirects the light to lens 60 which recreates the image at 70. At all of the image planes, a modular mounting standard 80 creates a port.

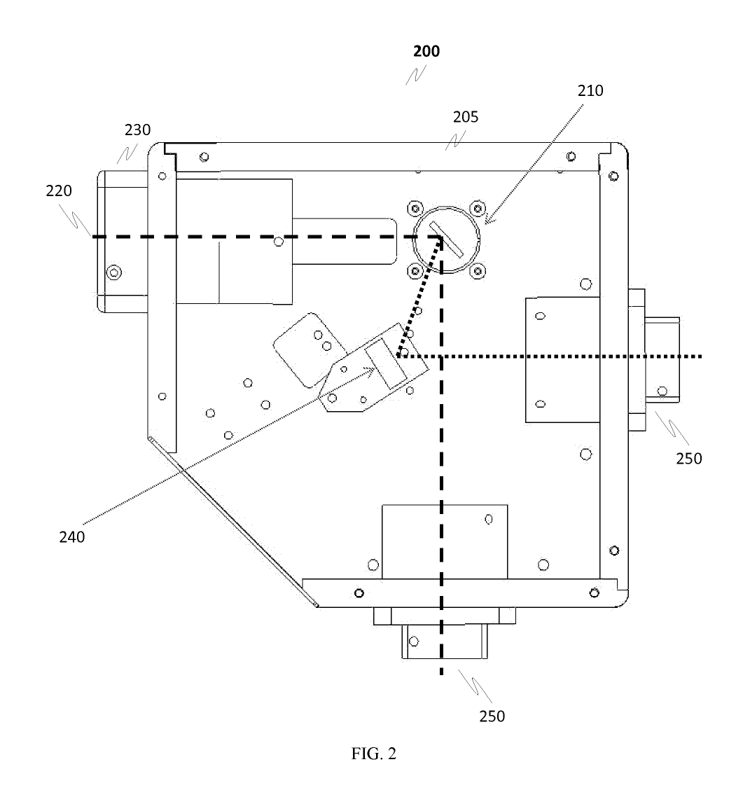

FIG. 2 illustrates an exemplary port switching device 200 in housing 205, such as a modular, scalable housing that is capable of being interconnected with other modular unit(s). A galvanometer is held with the hardware 210 to be within the optical pathway. The image enters the input port 220 using the standard mounting hardware 230. Lenses create two optical paths from the galvanometer; one path includes a fixed mirror 240 for convenience. The image then exits at the standard mounting ports 250.

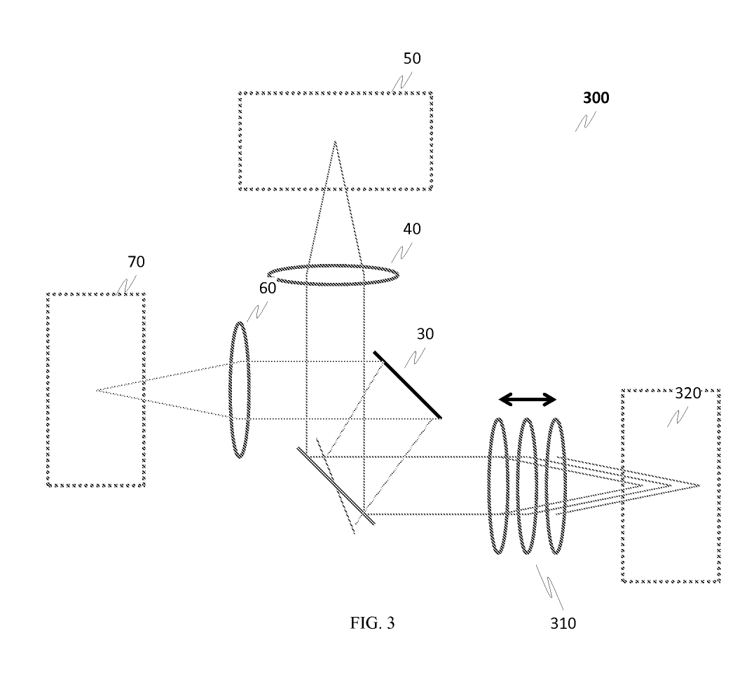

FIG. 3 illustrates an exemplary optical diagram of a port switcher 300 including spherical aberration correction. This diagram is the same as in FIG. 1, but here the input imaging lens 310 can be moved (using a controller/computer/motorization controller and associated motor(s)—not shown) along the optical axis. This allows selection of the desired plane from the focal volume 320.

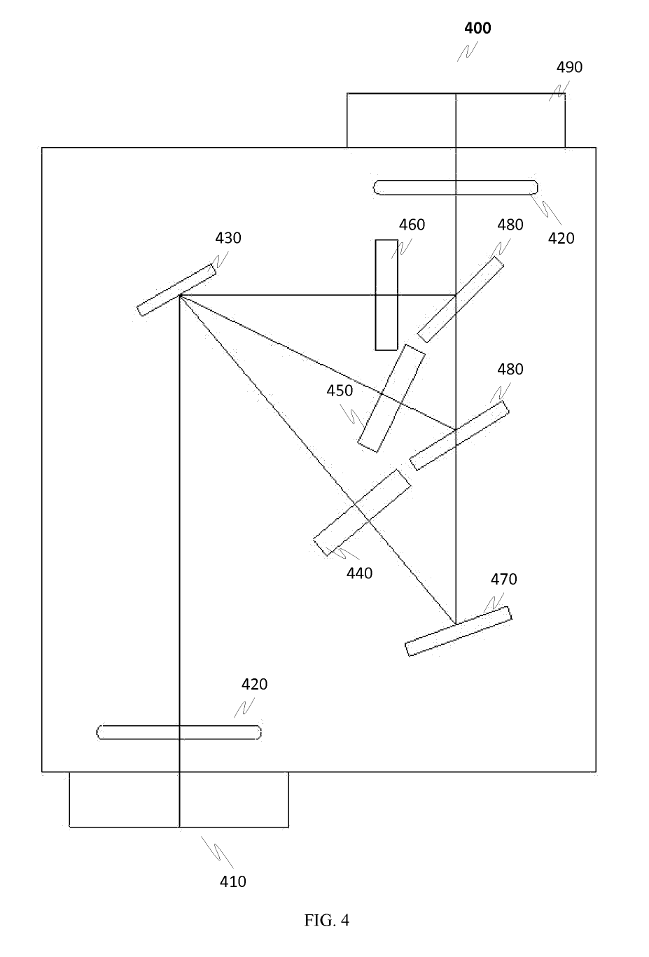

FIG. 4 illustrates an exemplary optical diagram of a filter switching device. The image enters the input port 410 and is cast to infinity by lenses 420. The galvanometer 430 sends the image through one of the filters 440, 450, or 460. A mirror 470 and polychromatic mirrors 480 recombine the optical paths and the image exits at 490.

The exemplary techniques illustrated herein are not limited to the specifically illustrated embodiments but can also be utilized with the other exemplary embodiments and each described feature is individually and separately claimable.

The systems of this invention also can cooperate and interface with a special purpose computer, a general purpose computer including a controller/processor and memory/storage, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like. The term module as used herein can refer to any known or later developed hardware, software, firmware, or combination thereof, that is capable of performing the functionality associated with that element. The terms determine, calculate, and compute and variations thereof, as used herein are used interchangeable and include any type of methodology, process, technique, mathematical operational or protocol.

Furthermore, the disclosed system may use control methods and graphical user interfaces that may be readily implemented in software using object or object-oriented software development environments that provide portable source code that can be used on a variety of computer or workstation platforms that include a processor and memory. Alternatively, the disclosed control methods may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

It is therefore apparent that there has been provided, in accordance with the present invention microscopy-type devices. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A microscope system switching device comprising:
a relay system that redirects an image along more than one optical path using a a reflecting device; and
means for controlling a motion of the reflecting device.

2. The system of claim 1, wherein the device is external to the microscope.

3. The system of claim 2, wherein the reflecting device is a mirror.

4. The system of claim 3, wherein the mirror is turned with a galvanometer.

5. The system of claim 1, further comprising a synchronization controller that synchronizes one or more imaging devices and the motion control means.

6. The system of claim 1, further comprising means for controlling the motion of the reflecting device using a computer.

7. The system of claim 3, further comprising a modular device.

8. The system of claim 7, wherein ports of the modular device adhere to an optical and mechanical standard to facilitate combination with other devices.

9. The system of claim 5, wherein motion can occur during a transfer time of the imaging device.

10. The system of claim 1, further comprising a means to move an input lens along an optical axis.

11. The system of claim 10, wherein a moving lens is used to select a desired image plane from a focal volume.

12. The system of claim 11, wherein the motion of the input lens is automated.

13. The system of claim 12, wherein the motion of the input lens and the reflecting device are synchronized.

14. The system of claim 1, further comprising optical means to recombine several optical paths.

15. The system of claim 14, where the means for redirecting the optical path contains a galvanometer.

16. The system of claim 14, where optical elements are placed in the several optical paths, such that the device can select from the several optical elements.

17. The system of claim 16, where the optical elements are one or more of polychromatic filters and colored glass.

18. The system of claim 16, where the optical elements are birefringent or are polarizers.

19. The system of claim 14, where the means for recombining the optical paths includes mirrors and polychromatic mirrors.

20. The system of claim 14, further comprising a means for integrating spherical aberration correction with the device.

21. The system of claim 14, further comprising means for splitting the combined optical output into one of several optical paths.

22. The system of claim 14, wherein a motion of a galvanometer is synchronized using a computer, synchronization hardware or a camera.

23. A microscope system including port switcher comprising:
a relay system including at least two optical paths selected by a reflective device;
means for moving the reflective device;
means for controlling a motion of the reflective device to select a desired optical path, wherein the reflective device is motorized by a galvanometer, the means for moving the reflective device is synchronized with a detector and the reflective device can be moved in less than a transfer time of an imaging camera.
